(19) United States
(12) Patent Application Publication
(10) Pub. No.: US 2014/0161949 A1
(43) Pub. Date: Jun. 12, 2014

(54) METHOD OF MANUFACTURING DOG TREAT

(71) Applicant: Ronnie Albeg, East Hills, NY (US)

(72) Inventor: Ronnie Albeg, East Hills, NY (US)

(21) Appl. No.: 13/710,433

(22) Filed: Dec. 10, 2012

(51) Int. Cl. A23K 3/00

(52) U.S. Cl. CPC A23K 3/005
USPC 426/417

(57) ABSTRACT

A method of manufacturing pet treats includes the steps of pressing, freezing, slicing and dehydrating un-ground meat. The pressing and freezing may be done by placing chunks of meat into nestable containers and placing the containers one into another so that the weight of the containers presses the meat below, then placing the stack of containers in a freezer and allowing it to freeze. The meat is then sliced into strips and the strips dehydrated. The seasoning, additives and other ingredients may be limited to only sea salt.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### CROSS-REFERENCE TO RELATED APPLICATIONS

N/A

### FIELD OF THE INVENTION

This invention relates generally to animal and pet care, and specifically to pet treats of the jerky type, with strips of jerked meat as a treat for dogs and other pets.

### STATEMENT REGARDING FEDERALLY FUNDED RESEARCH

This invention was not made under contract with an agency of the US Government, nor by any agency of the US Government.

### BACKGROUND OF THE INVENTION

Pet treats are an increasing source of problems for animals and their owners. Due to the pressure of increased competition and international trade, pet treats may be found to be unhealthy for animals. Certain types of problems are well known, such as the use of corn in pet food, despite that fact that it is not digestible and greatly increases the quantity of pet wastes for owners to clean up.

Other problems are more serious. The US Food and Drug Administration has now released repeated warnings about chicken jerky treats imported from China. The first such warning was issued in September of 2007, and was followed by another in December of 2008. A third warning from the FDA came in November 2011 and yet another in September of 2012, that is, mere weeks before the application date of the present invention.

Similar investigations are under way in Australia, also relating to imported pet treats.

The FDA report dated Sep. 14, 2012, contains the rather startling statement: “The FDA has received approximately 2,200 reports of pet illnesses which may be related to consumption of the jerky treats. The majority of the complaints involve dogs, but cats also have been affected. Over the past 18 months the reports have contained information on 360 canine deaths and one feline death. There does not appear to be a geographic pattern to the case reports. Cases have been reported from all 50 states and 6 Canadian provinces in the past 18 months.”

The same FDA warning added, “In the past 10 years, there has been a dramatic increase in importation of pet food from China. Human consumption of poultry in China largely consists of dark meat, leaving a large amount of light meat poultry products available for export. From 2003, when China first approached the USDA about poultry exports, to 2011, the volume of pet food exports (regulated by the FDA) to the United States from China has grown 85-fold. It is estimated that nearly 86 million pounds of pet food came from China in 2011. Pet treats, including jerky pet treats are currently considered the fastest growing segment in the pet food market.”

The FDA report then continues with a listing of symptoms the animal can expect and a long discussion of the numerous potential causes which the FDA is examining. (These include Salmonella, metals, furans, pesticides, antibiotics, mycotoxins, rodenticides, nephrotoxins (such as aristolochic acid, maleic acid, paraquat, ethylene glycol, diethylene glycol, toxic hydrocarbons, melamine, and related triazines) and were screened for other chemicals and poisonous compounds.) The FDA notes that none of these tests were positive, resulting in the FDA carrying out plant inspections in China, expanding the search to include heavy metals and so on and so forth.

In general but without this particular medical mystery, the same general situation applies in regard to most forms of meat, not just chicken but also duck products, pork products, cattle products and so on. That is, the meat used for pet treats may be heavily processed, may include various additives and so on. Since the pet treat is for animals, it is usual to apply lower standards to safety than would be applied to food for human consumption.

In addition, many processes for preparation of pet treats involve overly complex steps including forming it into continuous sheets, using complicated rollers and so on. A review of the patent literature on the topic reveals that most processes for creation of animal treats involve the use of heavily processed meat, ground meat and the like, which meat products are then treated and prepared in such a way as to make them resemble strips of unprocessed meat. Certainly the appearance of unprocessed meat is desirable, however the compromises in most such processes are less desirable.

Thus, it is desirable to provide safe, sanitary, inexpensive methods of processing meat into pet treats.

### SUMMARY OF THE INVENTION

### General Summary

The present invention teaches a method which combines freezing of high quality pet jerky meat with dehydration of the strips cut from the meat. In general, chunks of extra-lean beef, pork loin, chicken breast or very small chunks of meats such as duck or the like are washed with water, soaked in sea salt water, and stripped of fat. The pet jerky meat chunks are then place in flat containers which are stacked nested so that the weight of containers above presses the pet jerky meat into generally rectangular three dimensional (herein “rectanguloid”) bodies as they freeze in a freezer. These rectanguloid bodies are referred to herein as “cakes”, not to imply any bakery product but rather in the sense of being slabs or bars of material. The stacking may occur after, before or as the containers are placed in a freezer: the term “placed in a freezer” as used in the claims herein, and generally stated after the stacking, may refer to stacking after, before or as the containers are placed in a freezer. When the chunks of pet jerky meat have been frozen into rectanguloid cakes the cakes are removed and sliced into strips still frozen. These frozen strips are then placed on a perforated drying rack in a dehydrator and dehydrated.

The method of the invention means that pet treats produced thereby might qualify for various certifications such as “all natural”, “no artificial ingredients”, “no hormones or steroids”, “Product of the USA”, etc.

In alternative embodiments, a pressing machine may be used instead of the nestable containers.

### Summary in Reference to Claims

It is therefore an aspect, advantage, objective and embodiment of the present invention, in addition to those listed previously, to provide a method of producing pet treats, comprising the following steps:

a) providing chunks of pet jerky meat, said chunks being of a size ranging from 1 to 24 inches in average dimension;
b) placing said chunks of pet jerky meat in a first vat having a minimum capacity of ½ quart
c) washing said chunks of pet jerky meat in said vat by repeatedly rinsing them with fresh water and draining away said fresh water;
d) moving and soaking said chunks of pet jerky meat in a bath of water and light sea salt for a time of approximately 20 minutes or more;
e) removing from said chunks of meat all physically separable fat;
f) placing said chunks of meat into a plurality of containers, each container having a weight and being generally rectanguloid in shape but having a cross-section with a top and a bottom, such top being wider then such bottom, whereby such plurality of containers may nest with such bottom of a first such container inside of a second such container, and with the top of the first container projecting out of the top of the second container;
g) stacking such containers containing chunks of meat, with such bottom of each container resting upon such chunks of meat within such container immediately below, whereby such chunks of meat are pressed by such weight of such container resting upon them;
h) placing such stack of containers in a freezer;
i) allowing such chunks of meat to freeze while pressed by such weight of such container resting upon them; whereby such chunks of meat are frozen into rectanguloid cakes/bars/slabs;
j) removing such rectanguloid cakes from such containers;
k) slicing such rectanguloid cakes into frozen strips;
l) placing such frozen strips flat upon a perforated tray;
m) placing such perforated tray into a dehydrator;
n) dehydrating such frozen strips;
o) cooling such frozen strips to room temperature.

It is therefore an aspect, advantage, objective and embodiment of the present invention to provide a method of producing pet treats, wherein such pet jerky meat further comprises un-ground chicken breast chunks.

It is therefore an aspect, advantage, objective and embodiment of the present invention to provide a method of producing pet treats, wherein such pet jerky meat further comprises un-ground pork loin chunks.

It is therefore an aspect, advantage, objective and embodiment of the present invention to provide a method of producing pet treats, wherein such pet jerky meat further comprises un-ground extra-lean beef with the fat removed.

It is therefore an aspect, advantage, objective and embodiment of the present invention to provide a method of producing pet treats, wherein such pet jerky meat further comprises small chunks of duck meat.

It is therefore an aspect, advantage, objective and embodiment of the present invention to provide a method of producing pet treats, wherein such sea salt is the only additive used in preparation of the pet treat.

It is therefore another aspect, advantage, objective and embodiment of the present invention to provide a method of producing pet treats, wherein such containers further comprise rectanguloids having a top length from 10 to 24 inches, a height from 1.5 to 4 inches and a top width from 4 to 8 inches.

It is therefore an aspect, advantage, objective and embodiment of the present invention to provide a method of producing pet treats, wherein such freezing further comprises reducing such rectanguloid cakes to a temperature from 10 to 32 degrees Fahrenheit.

It is therefore an aspect, advantage, objective and embodiment of the present invention to provide a method of producing pet treats, wherein such slicing further comprises slicing such strips to a length from 4 to 8 inches and a thickness from ¼ to ¾ inches.

It is therefore yet another aspect, advantage, objective and embodiment of the present invention to provide a method of producing pet treats, wherein such dehydration further comprises maintaining such strips at a temperature of at least 160 degrees Fahrenheit for a time from 6 to 24 hours.

It is therefore an aspect, advantage, objective and embodiment of the present invention to provide a method of producing pet treats, comprising the following steps:

a) providing chunks of pet jerky meat, said chunks being of a size ranging from 1 to 24 inches in average dimension;
b) placing said chunks of pet jerky meat in a first vat having a minimum capacity of ½ quart;
c) washing said chunks of pet jerky meat in said first vat by repeatedly rinsing them with fresh water and draining away said water;
d) moving and soaking said chunks of pet jerky meat in a second vat in a bath of water and sea salt for a time of approximately 20 minutes or more;
e) removing from said chunks of meat all physically separable fat;
f) placing said chunks of meat into a pressing machine;
g) pressing such chunks of meat into rectanguloid cakes;
h) placing such rectanguloid cakes in a freezer;
i) allowing such rectanguloid cakes to freeze;
j) removing such rectanguloid cakes from such freezer;
k) slicing such rectanguloid cakes into frozen strips;
l) placing such frozen strips flat upon a perforated tray;
m) placing such perforated tray into a dehydrator;
n) dehydrating such frozen strips;
o) cooling such frozen strips to room temperature.

### BRIEF DESCRIPTION OF THE DRAWINGS

FIG. 1 is a flow chart depicting preferred and alternative embodiments of the method of the invention.

FIG. 2 is a cross-sectional side view of a single container such as might be used in the preferred embodiment method of the invention.

FIG. 3 is a cross-sectional side view of a stack of containers containing and pressing chunks of meat, such as might be used in the preferred embodiment method of the invention.

### INDEX TO REFERENCE NUMERALS

Provide un-ground chunks of pet jerky meat 102
Place in vat 104
Wash with water 106
Soak in sea salt water for minimum of 20 minutes 108
Remove fat 110
Place in container 112
Place in pressing machine 113
Stack such containers 114
Press into cakes 115
Place stack in freezer 116
Place in freezer 117
Allow to freeze into cakes 118
Remove from freezer 120
Slice cakes into strips 122
Place strips in perforated tray 124
Place tray into dehydrator 126
Dehydrate strips 128
Cool 130
Bottom 204
Bottom length 206
Top length 208
Height 210
Top width 212
Bottom width 214
Meat, chunks combined into cakes 216
Optional weight 218

### DETAILED DESCRIPTION

In the presently preferred embodiment and best mode presently contemplated for carrying out the invention, pet jerky meat is provided in chunks, cleaned, soaked in seal salt water, pressed in stacked containers, frozen and sliced while frozen, then dehydrated.

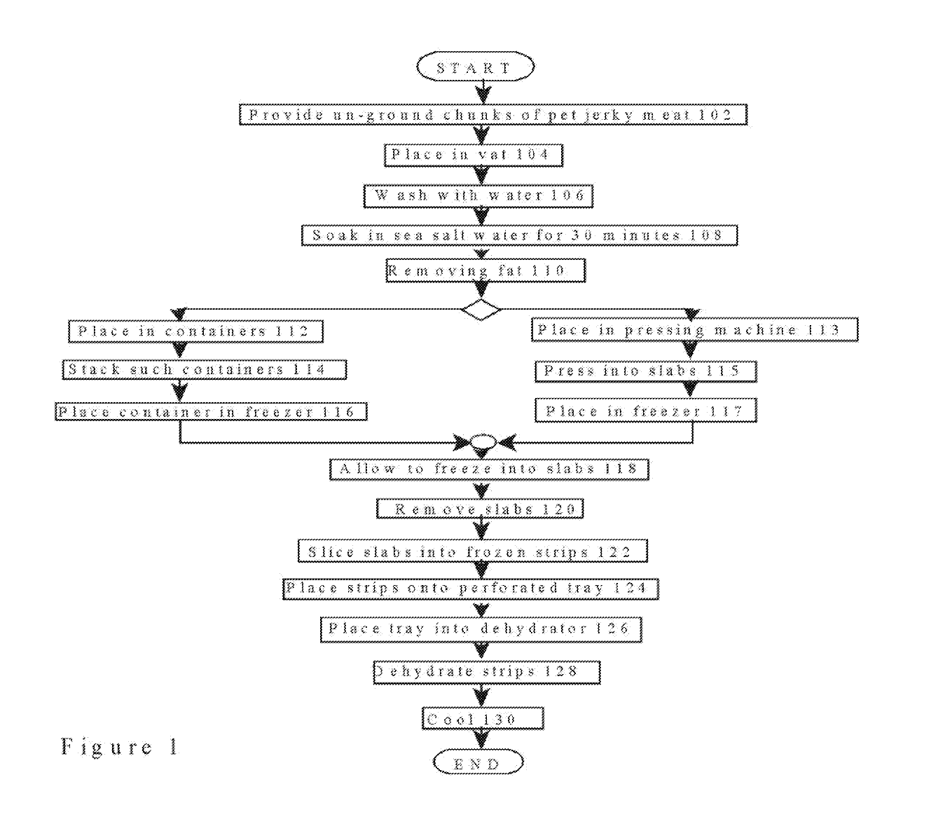

FIG. 1 is a flow chart depicting both the preferred and alternative embodiments of the method of the invention. The first step in the process is the provision of high quality meat. In general, the pet jerky meat to be used in the invention may be chunks of extra-lean beef, pork loin, chicken breast or very small chunks of meats such as duck or the like. Such non-ground meats obviously provide the best nutrition for animals requiring a high protein content in their diet. Thus step one of the process is to provide un-ground chunks of pet jerky meat, step 102.

The pet jerky meat is then placed in a large vat, step 104, generally a vat of a ½ quart to 4 gallon capacity. The vat may be a sink or stainless steel container or the like. Washing with fresh water, 106, is the next step of the invention, this is non-salt water. Since the meat tends to be unsightly when fresh, this step helps not just to cleanse the chunks of pet jerky meat but also to remove unwanted detritus.

The pet jerky meat is then moved into a second vat for a light sea salt soaking Importantly, the only seasoning, additive, hormone, or other ingredient contemplated in the method of the invention is a small amount of sea salt which may season the meat while the meat is being soaked in sea salt water for a period of time, step 108. This diluted sea salt is referred to herein as “light” sea salt. While this step is generally a matter of cleaning the meat properly, a mild seasoning effect may occur. In addition, by avoiding the use of other chemicals, preservatives and so on a much more natural product is created. While the preferred period of time is approximately 30 minutes, a time period in excess of 20 minutes may be used.

Removal of fat in step 110 involves physical chopping of concentrations of fat from the meat, not to any chemical process. Obviously, removal of fat is beneficial not just to the final consumer (the pet) but also to the quality of the product and is useful for the dehydration step near the end of the process.

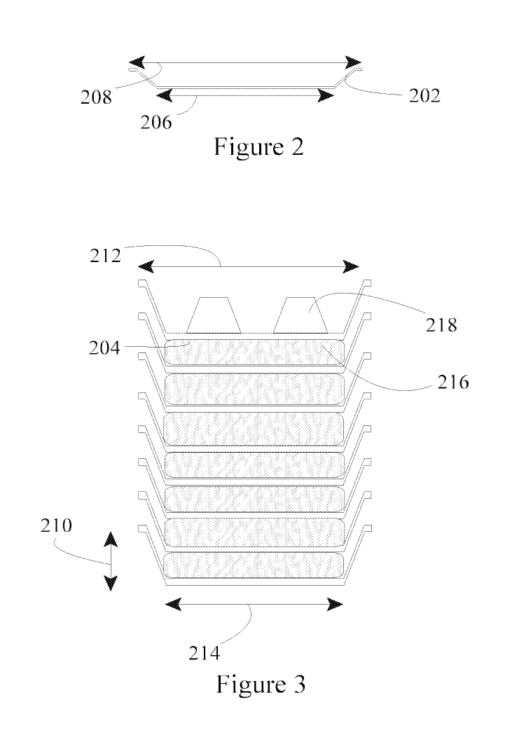

After the removal of fat, the meat is next placed in a container, step 112. The container is one which has certain characteristics. It is a food grade quality container which is “nestable”, meaning that one container can be placed partially into another container. Thus if the container is generally a rectangular body (“rectanguloid”) with an open top, and a closed bottom, it has not just a depth but also a length and width, and the length at the top is greater than the length at the bottom, and the width at the top is greater than the width at the bottom. As a result, when the containers are stacked they nest one into the next one, with only the top portion of each projecting from the one below it. (This will be seen better later in reference to FIGS. 2 and 3.)

Such containers may be conveniently handled manually. For example, they may range in length from 10 to 24 inches, may be 1.5 to 4 inches in height and may range in width from 4 to 8 inches, with the bottom dimensions of the containers obviously slightly smaller than the tops.

When chunks of pet jerky meat are placed in such containers, they fill the bottom, and if another container is then placed atop the first one, the weight of the upper container will rest upon the meat in the container below. This stacking of such containers, step 114, thus results in a gentle pressing of the chunks of pet jerky meat into a shape generally conforming to the rectanguloid shape of the bottom of the container interior. If the stacking is done in a freezer, or if the stack is placed in a freezer (all such being referred to by the term “placed in a freezer 116”, whether before, during or after stacking) then time will allow the chunks to freeze into rectanguloid cakes of meat 118. An example temperature range might be 10 to 32 degrees Fahrenheit. Note that the word “cake” as used herein does not in any way refer to a bakery product but rather to rectanguloid bar of material.

Removing the cakes from the freezer, 120 and slicing the cakes into strips 122 is the point at which the chunks of meat begin to resemble more of strips of pet jerky, however, the strips tend to be somewhat rectangular at this point. Slicing may be done on a commercial slicer which slices the entire cake of meat at a single time. Slicing may range in length from 6 to 8 inches and in thickness from 2/8 inch up to 6/8 inch (¼ to ¾ inches). The width of the slices may be from ½ inch to 2 inches.

Placing the strips in/on a perforated tray 124 is the step which precedes placing the tray into a dehydrator 126 and then the step 128, of dehydrating the strips, and cooling them down 130. Such dehydration may occur from 6 to 24 hours in the time, one standard is 160 degrees Fahrenheit for 10 hours, however, a time of 18 hours at this temperature, with an additional 4 hour warm—up and 2 hour cool down, is preferable. Note that such times and temperatures will depend upon the type of oven used. Naturally, larger ovens with more blowers will reduce the time.

In an alternative embodiment of the invention, a pressing machine may be used for the step of pressing the chunks into frozen cakes. If so, then instead of steps 112, 114 and 116, the chunks of pet jerky meat are placed in a pressing machine 113, pressed into cakes 115 by means of the pressing machine, and then frozen, step 117. This option may be more suited to larger production batches.

Either embodiment allows the pressing of the pet jerky meat into a convenient and frozen shape, followed by the slicing and dehydration of the pet jerky meat, without seasoning and without using ground or processed meats.

FIG. 2 is a cross-sectional side view of a single container such as might be used in the preferred embodiment method of the invention, while FIG. 3 is a cross-sectional side view of a stack of containers containing and pressing chunks of meat, such as might be used in the preferred embodiment method of the invention.

Container 202 has bottom 204 having bottom length 206, and also has a top length 208, as well as a height 210 and a top width 212 and a bottom width 214. Pet jerky meat, that is chunks, which have been combined into cakes 216 may be seen to being pressed and frozen prior to the slicing and dehydration steps.

Optional weight 218 may be used to provide extra weight, for example, for the uppermost cake in the stack.

The disclosure is provided to allow practice of the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the appended claims.

What is claimed is:

1. A method of producing pet treats, comprising the following steps:
a) providing chunks of pet jerky meat, said chunks being of a size ranging from 1 to 24 inches in average dimension;
b) placing said chunks of pet jerky meat in a first vat having a minimum capacity of ½ quart;
c) washing said chunks of pet jerky meat in said first vat by repeatedly rinsing them with fresh water and draining away said fresh water;
d) moving and soaking said chunks of pet jerky meat in a bath of water and light sea salt for a time of approximately 20 minutes or more;
e) removing from said chunks of meat all physically separable fat;
f) placing said chunks of meat into a plurality of containers, each container having a weight and being generally rectanguloid in shape but having a cross-section with a top and a bottom, such top being wider then such bottom, whereby such plurality of containers may nest with such bottom of a first such container inside of a second such container, and with the top of the first container projecting out of the top of the second container;
g) stacking such containers containing chunks of meat, with such bottom of each container resting upon such chunks of meat within such container immediately below, whereby such chunks of meat are pressed by such weight of such container resting upon them;
h) placing such stack of containers in a freezer;
i) allowing such chunks of meat to freeze while pressed by such weight of such container resting upon them; whereby such chunks of meat are frozen into rectanguloid cakes;
j) removing such rectanguloid cakes from such containers;
k) slicing such rectanguloid cakes into frozen strips;
l) placing such frozen strips flat upon a perforated tray;
m) placing such perforated tray into a dehydrator;
n) dehydrating such frozen strips;
o) cooling such frozen strips to room temperature.

2. The method of producing pet treats of claim 1, wherein such pet jerky meat further comprises un-ground chicken breast chunks.

3. The method of producing pet treats of claim 1, wherein such pet jerky meat further comprises un-ground pork loin chunks.

4. The method of producing pet treats of claim 1, wherein such pet jerky meat further comprises un-ground extra-lean beef with the fat removed.

5. The method of producing pet treats of claim 1, wherein such pet jerky meat further comprises small chunks of duck meat.

6. The method of producing pet treats of claim 1, wherein such sea salt is the only additive used in preparation of the pet treat.

7. The method of producing pet treats of claim 1, wherein such containers further comprise rectanguloids having a top length from 10 to 24 inches, a height from 1.5 to 4 inches and a top width from 4 to 8 inches.

8. The method of producing pet treats of claim 1, wherein such freezing further comprises reducing such rectanguloid cakes to a temperature from 10 to 32 degrees Fahrenheit.

9. The method of producing pet treats of claim 1, wherein such slicing further comprises slicing such strips to a length from 6 to 8 inches and a thickness from ¼ to ¾ inches.

10. The method of producing pet treats of claim 1, wherein such dehydration further comprises maintaining such strips at a temperature of at least 160 degrees Fahrenheit for a time from 6 to 24 hours.

11. A method of producing pet treats comprising the following steps:
a) providing chunks of pet jerky meat, said chunks being of a size ranging from 1 to 24 inches in average dimension;
b) placing said chunks of pet jerky meat in a first vat having a minimum capacity of ½ quart;
c) washing said chunks of pet jerky meat in said first vat by repeatedly rinsing them with water and draining away said water;
d) moving and soaking said chunks of pet jerky meat in a second vat in a bath of water and light sea salt for a time of approximately 20 minutes or more;
e) removing from said chunks of meat all physically separable fat;
f) placing said chunks of meat into a pressing machine;
g) pressing such chunks of meat into rectanguloid cakes;
h) placing such rectanguloid cakes in a freezer;
i) allowing such rectanguloid cakes to freeze;
j) removing such rectanguloid cakes from such freezer;
k) slicing such rectanguloid cakes into frozen strips;
l) placing such frozen strips flat upon a perforated tray;
m) placing such perforated tray into a dehydrator;
n) dehydrating such frozen strips;
o) cooling such frozen strips to room temperature.
